(19) United States
(12) Patent Application Publication
(10) Pub. No.: US 2017/0017930 A1
(43) Pub. Date: Jan. 19, 2017

(54) SYSTEM AND METHOD FOR SCHEDULING HEALTHCARE FOLLOW-UP APPOINTMENTS BASED ON WRITTEN RECOMMENDATIONS

(71) Applicant: KONINKLIJKE PHILIPS N.V., Eindhoven (NL)

(72) Inventors: Ye Xu, Milford, CT (US); Yuechen Qian, Lexington, MA (US); Merlijn Sevenster, Chicago, IL (US)

(21) Appl. No.: 15/123,695

(22) PCT Filed: Mar. 2, 2015
(86) PCT No.: PCT/IB2015/051512

§ 371 Date: Sep. 6, 2016

Related U.S. Application Data
(60) Provisional application No. 61/952,167, filed on Mar. 13, 2014.

(51) Int. Cl. G06Q 10/10; G06F 19/00

(52) U.S. Cl. CPC G06Q 10/1095; G06F 19/321

(57) ABSTRACT

A system and method for analyzing a patient report to determine whether a follow-up has been recommended. The system and method perform the steps of extracting a portion of text indicating a follow-up recommendation from the report, extracting a name of the follow-up recommendation and determining a corresponding time interval from the portion of text, extracting context information relating to the patient report, and determining, based on the context information and the name of the follow-up recommendation, whether an appointment corresponding to the follow-up recommendation has been scheduled.

### BACKGROUND

Radiology reports include results of a reading of an imaging exam for a patient. These radiology reports may serve as a communication tool among radiologists, referring physicians and oncologists and may also include information regarding suggested follow-up and/or recommendations. These follow-up suggestions and recommendations may be especially helpful for referring physicians to quickly get an opinion from radiologists. However, these follow-up suggestions and recommendations are often buried within text of the radiology report and, if they do not address a primary reason for the exam, may go ignored. For example, a patient with a metastatic cancer may have, as an incidental finding, a serious vascular disease. The oncologist, who is the referring physician, may focus primarily on the cancer-related discussion and may not always follow up promptly on recommendations that fall outside this domain of attention. Thus, in such situations, it may be beneficial for a healthcare provider or health administrator to automatically send an alert to referring physicians and/or radiologists regarding the suggestions/recommendations.

### SUMMARY OF THE INVENTION

A method for analyzing a patient report to determine whether a follow-up has been recommended. The method including extracting a portion of text indicating a follow-up recommendation from the report, extracting a name of the follow-up recommendation and determining a corresponding time interval from the portion of text, extracting context information relating to the patient report, and determining, based on the context information and the name of the follow-up recommendation, whether an appointment corresponding to the follow-up recommendation has been scheduled.

A system for analyzing a patient report to determine whether a follow-up has been recommended. The system including a processor extracting a portion of text indicating a follow-up recommendation from the report, extracting a name of the follow-up recommendation and determining a corresponding time interval from the portion of text, extracting context information relating to the patient report and determining, based on the context information and the name of the follow-up recommendation, whether an appointment corresponding to the follow-up recommendation has been scheduled

### BRIEF DESCRIPTION OF THE DRAWINGS

FIG. 1 shows a schematic drawing of a system according to an exemplar embodiment.

FIG. 2 shows another schematic drawing of the system of FIG. 1.

FIG. 3 shows a flow diagram of a method according to an exemplary embodiment.

FIG. 4 shows a table of exemplary categories of follow-up/recommendations.

### DETAILED DESCRIPTION

The exemplary embodiments may be further understood with reference to the following description and the appended drawings wherein like elements are referred to with the same reference numerals. The exemplary embodiments relate to a system and method for identifying follow-up suggestions and recommendations. In particular, the exemplary embodiments describe generating an alert for patients requiring follow-up studies within a recommended time frame. Although the exemplary embodiments specifically describe identifying information contained within a radiology report, it will be understood by those of skill in the art that the system and method of the present disclosure may be used to identify suggestions and recommendations contained within any text report for a patient within any of a variety of hospital department.

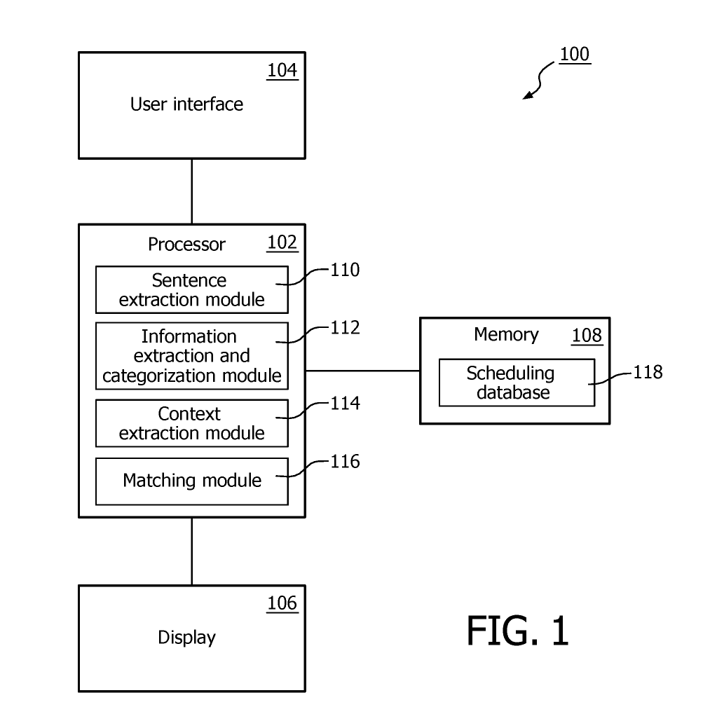

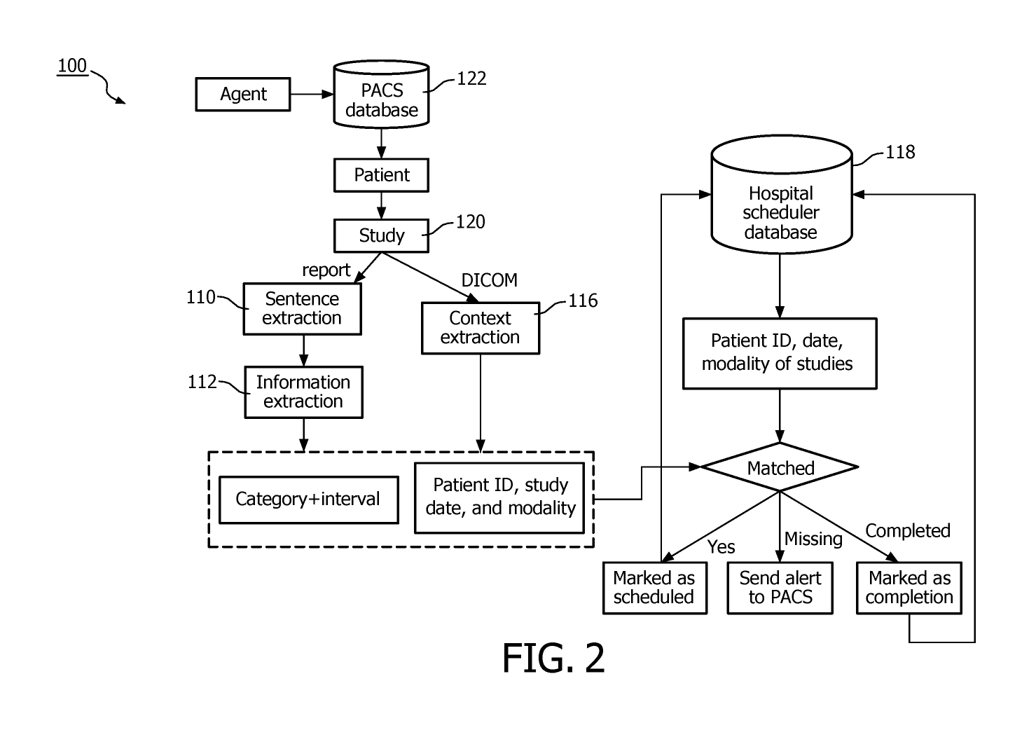

As shown in FIGS. 1 and 2, a system 100 according to an exemplary embodiment of the present disclosure identifies follow-up suggestions and other recommendations contained within a report 120. The identified follow-up and recommendations may be used to generate an alert to a user (e.g., referring physician, oncologist) that a follow-up study is suggested or required. The system 100 comprises a processor 102, a user interface 104, a display 106 and a memory 108 on which the report 120 for a patient is stored. A radiology report, for example, is a reading of results of an imaging exam for the patient and may include relevant information regarding findings in the image along with follow-up suggestions and recommendations. The report 120 may be structured to include separate sections such as, for example, CLINICAL INFORMATION, COMPARISON, FINDINGS, IMPRESSIONS and RECOMMENDATION. Follow-up suggestions and recommendations may be found, for example, in the IMPRESSIONS and/or RECOMMENDATION sections of the report 120.

The processor 102 may include a sentence extraction module 110, an information extraction and categorization module 112, a context extraction module 114 and a matching module 116. The sentence extraction module 110 extracts sentences from the report including keywords or phrases (e.g., “recommend”, “suggest”, “consider”) indicating that a follow-up has been recommended. The sentence extraction module 110 may search specifically in the IMPRESSIONS and RECOMMENDATION sections of the report 120. It will be understood by those of skill in the art that the sentence extraction module 110 may be preprogrammed to search text within particular sections of the report 120 or, alternatively, the entire report 120. The information extraction and categorization module 112 analyzes each of the extracted sentences to determine a recommendation category for each follow-up suggestion and a time interval in which the follow-up is required. The context extraction module 114 extracts context information for the report 120 and the patient including, for example, patient identifying information, a study date (e.g., the date on which the image exam was conducted), and a modality (e.g., MRI, CT) of the study.

The matching module 116 then searches a scheduling database 118, which may be stored in the memory 108, to match the extracted context information to a patient record in the scheduling database 118. The scheduling database 118 may be a hospital-wide scheduling tool including all scheduled appointments within all departments of the hospital. Once the patient record is identified in the scheduling database 118, the matching module 116 searches the patient record to determine whether the extracted recommendation category and time interval matches any appointment scheduled in the scheduling database. If a match is not found, the processor 102 may generate an alert, which automatically notifies the user (e.g., referring physician) or patient that a follow-up should be scheduled. This alert may be displayed on the display 106. It will be understood by those of skill in the art, however, that other information such as, for example, the report 120, the identified patient record in the scheduling database 118, the extracted follow-up recommendation categories and intervals may also be displayed on the display 106. The user may also edit and/or set parameters for the sentence extraction module 110, the information extraction and categorization module 112, the context extraction module 114 and the matching module 116 via the user interface 104 which may include input devices such as, for example, a keyboard, a mouse and/or touch display on the display 106.

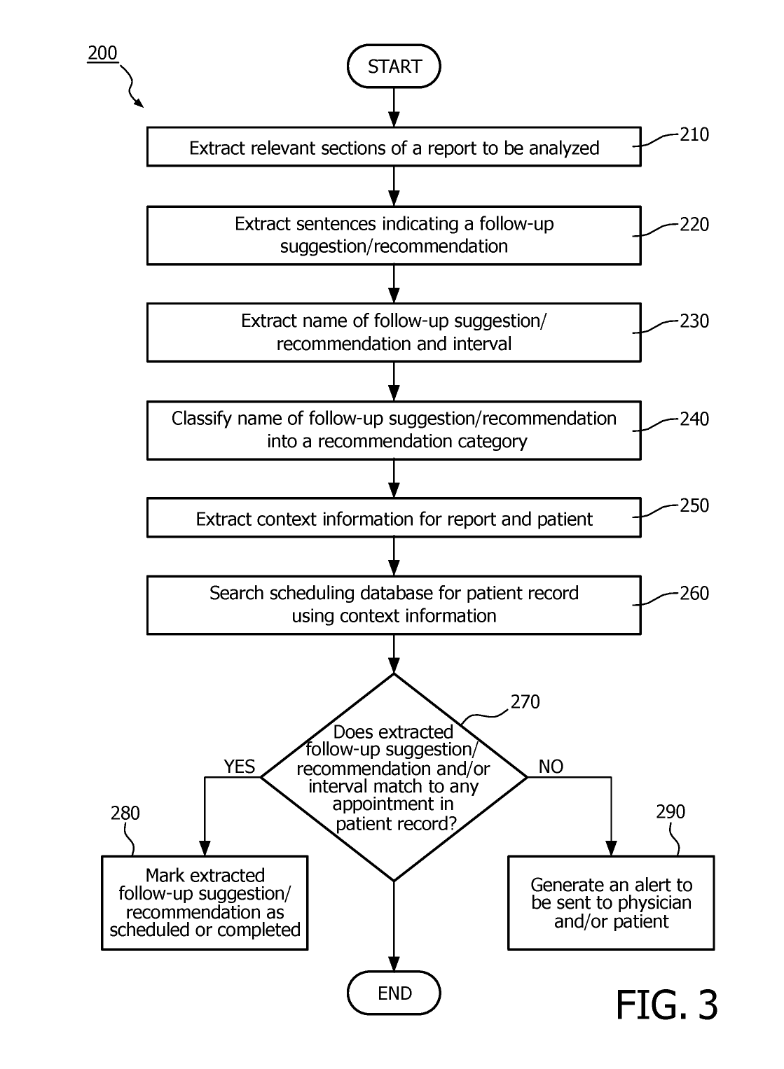

FIG. 3 shows a method 200 for determining whether a follow-up study has been recommended using the system 100 described above. The method 200 comprises steps for reviewing reports 120 which may be stored and viewed in, for example, a Picture Archiving and Communications System (PACS) database 122 within a Radiology Information System (RIS). These reports 120 may be retrieved from and/or stored in the memory 108. In a step 210, relevant sections are extracted from the report 120. For example, where the report 120 is a radiology report including the five sections: CLINICAL INFORMATION, COMPARISON, FINDINGS, IMPRESSIONS and RECOMMENDATION—the IMPRESSIONS and RECOMMENDATION sections may be extracted since follow-up suggestions and recommendations are known to be generally included in these sections. It will be understood by those of skill in the art, however, that the method 200 may be adjusted to account for reports including alternate headings and/or sections. It will also be understood by those of skill in the art that the system 100 may be adjusted to extract all text portions of the report 120 such that the sentence extraction module 110 may search all of the text of the entire report 120.

In a step 220, the sentence extraction module 110 may utilize a Natural Language Processing (NLP) module to search the extracted sections and extract sentences which indicate that a follow-up study has been suggested or other recommendations have been made. The sentence extraction module 110 may identify these sentences by searching keywords or phrases such as, for example, “follow up”, “suggest”, “consider”, “f/s” (follow-up or suggested), etc. Alternate semantic representations, concepts and phrases using proprietary or third-party technology may also be searched. For example, the sentence extraction module may extract a sentence which states: “Left unilateral mammogram in 6 months is recommended.” In a step 230, the information extraction and categorization module 112 extracts, from each extracted sentence, a name of the follow-up suggestion/recommendation (e.g., mammogram) along with a time interval (e.g., 6 months) during which the follow-up should take place. The name of the follow-up suggestion/recommendation may be identified via, for example, a name of an imaging, testing, therapy, biopsy, etc. The interval may be identified via terms such as, for example, annually, month, routinely, immediately, etc. Where a name of a follow-up suggestion/recommendation has been extracted, but no interval can be identified, the information extraction and categorization module 112 may default to a preset interval of, for example, “immediately.” Although the exemplary embodiment describes the extraction and analysis of sentences, it will be understood by those of skill in the art that the sentence extraction module 110 may extract other discernible sections or portions text such as, for example, paragraphs.

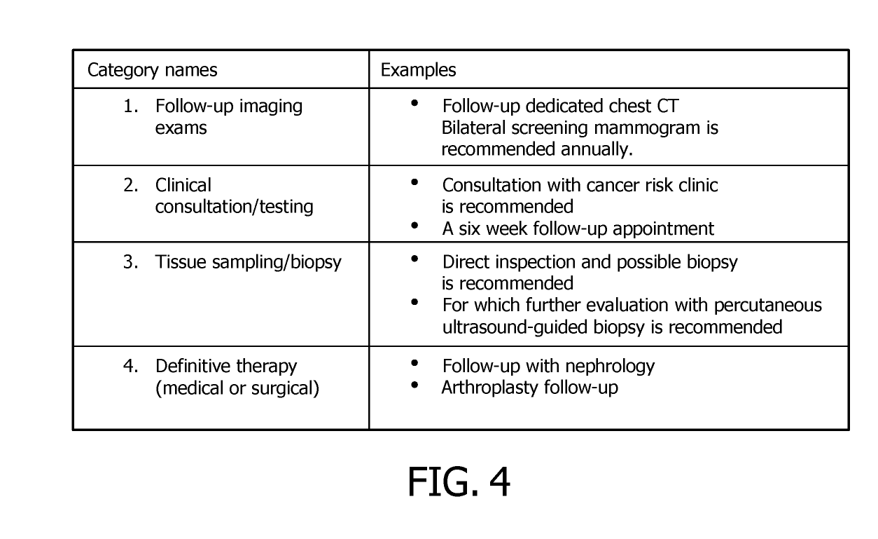

Once the name of the recommendation has been identified, the information extraction and categorization module 112 classifies the extracted follow-up and corresponding interval into a recommendation category, in a step 240. In an exemplary embodiment, the system 100 may include four recommendation categories including: (1) follow-up imaging exams, (2) clinical consultation/testing, (3) tissue sampling/biopsy, and (4) definitive therapy. FIG. 4 shows the four recommendation categories and exemplary follow-up suggestions/recommendations falling within each of the identified categories. The extracted follow-up is classified into one of the recognized recommendation categories using regular expressions that have been identified as indicating a particular category or trained patterns in a machine learning process. For example, a pattern for the follow-up imaging exams category may be “imaging name+verb of follow-up and recommendation” or “verb of follow-up and recommendation+imaging name”. Characters may exist between or before the two terms (e.g., imaging name and verb). Imaging names may include, for example, CT, MRI, mammogram, screening, ultrasound, etc. The verb of the follow-up and recommendation may include, for example, recommend, suggest, consider, f/s, etc.

In a step 250, the context extraction module 114 extracts context information related to the report 120 and the patient including, for example, patient identifying information, study date, organ and modality. Images stored and viewed in, for example, the RIS/PACS system, for example, may be viewed in a DICOM (Digital Imaging and Communications in Medicine) format, which includes a header containing relevant context information. In a step 260, the matching module 116 searches the scheduling database 118, using the extracted context information, for a matching patient record. The patient record may then be searched, in a step 270 to determine whether an appointment for each of the identified follow-up suggestion/recommendation has been scheduled. In particular, the matching module 116 may search the patient record to determine whether any scheduled appointments match the identified recommendation category and interval. For example, the matching module 116 may search the patient record for an imaging exam (e.g., a mammogram) scheduled for 6 months after the study date. The matching module 116 may be preset to search a range of time for a given interval. For example, where the extracted interval is 6 months, the matching module 116 may search the patient record for appointments within a month of the 6 month interval. It will be understood by those of skill in the art that this range of time may be adjusted by the user, as desired. It will also be understood by those of skill in the art that the extracted interval may be used as a starting point for searching the patient record. For example, the matching module 116 may search the entire patient record beginning from 6 months from the study date. In another example, where the extracted interval or the defaulted interval is “immediately,” the matching module 116 may search the patient record beginning from the study date.

If the matching module 116 is able to match the context information, name or category of the follow-up suggestion/recommendation and/or interval to an appointment scheduled for the patient in the scheduling database 118, the method 200 proceeds to a step 280 and marks the follow-up suggestion/recommendation as scheduled or completed. Where the date of the appointment has not yet passed, the follow-up suggestion may be marked as scheduled. Where the date of the appointment has passed, the follow-up suggestion may be marked as completed. If the matching module 116 is not able to match the context information, name or category of the follow-up suggestion/recommendation and/or interval to an appointment scheduled in the patient record, the method 200 proceeds to a step 290. In the step 290, the processor 102 generates an alert to be sent to a physician (e.g., referring physician) or patient. This alert may, for example, be sent to the PACS system which may, in turn, automatically send a reminder than an appointment for the follow-up suggestion/recommendation should be scheduled. This reminder may be in the form of an email to the physician or patient.

It is noted that the claims may include reference signs/numerals in accordance with PCT Rule 6.2(b). However, the present claims should not be considered to be limited to the exemplary embodiments corresponding to the reference signs/numerals.

Those skilled in the art will understand that the above-described exemplary embodiments may be implemented in any number of manners, including, as a separate software module, as a combination of hardware and software, etc. For example, the sentence extraction module 110, the information extraction and categorization module 112, the context extraction module 114 and the matching module 116 may be programs containing lines of code that, when compiled, may be executed on a processor.

It will be apparent to those skilled in the art that various modifications may be made to the disclosed exemplary embodiments and methods and alternatives without departing from the spirit or scope of the disclosure. Thus, it is intended that the present disclosure cover the modifications and variations provided that they come within the scope of the appended claims and their equivalents.

1. A method for analyzing a patient report to determine whether a follow-up has been recommended, comprising:
extracting a portion of text indicating a follow-up recommendation from the report;
extracting a name of the follow-up recommendation and determining a corresponding time interval from the portion of text;
extracting context information relating to the patient report; and
determining, based on the context information and the name of the follow-up recommendation, whether an appointment corresponding to the follow-up recommendation has been scheduled.

2. The method of claim 1, further comprising:
generating an alert when it is determined that the appointment corresponding to the follow-up recommendation has not been scheduled.

3. The method of claim 1, wherein determining whether the appointment corresponding to the follow-up recommendation has been scheduled includes matching the context information and the name of the follow-up recommendation to appointments stored in a scheduling database relative to the time interval.

4. The method of claim 1, further comprising:
marking the follow-up recommendation as one of scheduled and completed when it is determined that an appointment corresponding to the follow-up recommendation has been scheduled.

5. The method of claim 1, wherein the time interval is one extracted from the portion of text and assigned a preset time period.

6. The method of claim 1, further comprising:
extracting relevant sections of the report such that the portion of text is extracted from the relevant sections of the report.

7. The method of claim 1, further comprising:
classifying the name of the follow-up recommendation into a follow-up category used to determine whether the appointment corresponding to the follow-up recommendation has been scheduled.

8. The method of claim 7, wherein the follow-up category includes one of follow up imaging exams, clinical consultation/testing, tissue sampling/biopsy and definitive therapy.

9. The method of claim 1, wherein the context information includes at least one of patient identifying information, study date, organ and modality.

10. The method of claim 1, wherein the name of the follow-up recommendation includes one of a name of an imaging, testing, therapy and biopsy.

11. A system for analyzing a patient report to determine whether a follow-up has been recommended, comprising:
a processor extracting a portion of text indicating a follow-up recommendation from the report, extracting a name of the follow-up recommendation and determining a corresponding time interval from the portion of text, extracting context information relating to the patient report and determining, based on the context information and the name of the follow-up recommendation, whether an appointment corresponding to the follow-up recommendation has been scheduled.

12. The system of claim 11, wherein the processor generates an alert when it is determined that the appointment corresponding to the follow-up recommendation has not been scheduled.

13. The system of claim 11, wherein determining whether the appointment corresponding to the follow-up recommendation has been scheduled includes matching the context information and the name of the follow-up recommendation to appointments stored in a scheduling database relative to the time interval.

14. The system of claim 11, wherein the processor marks the follow-up recommendation as one of scheduled and completed when it is determined that an appointment corresponding to the follow-up recommendation has been scheduled.

15. The system of claim 11, wherein the time interval is one extracted from the portion of text and assigned a preset time period.

16. The system of claim 11, wherein the processor extracts relevant sections of the report such that the portion of text is extracted from the relevant sections of the report.

17. The system of claim 11, wherein the processor classifies the name of the follow-up recommendation into a follow-up category used to determine whether the appointment corresponding to the follow-up recommendation has been scheduled.

18. The system of claim 11, wherein the follow-up category includes one of follow up imaging exams, clinical consultation/testing, tissue sampling/biopsy and definitive therapy.

19. The method of claim 1, wherein the context information includes at least one of patient identifying information, study date, organ and modality.

20. A non-transitory computer-readable storage medium including a set of instructions executable by a processor, the set of instructions, when executed by the processor, causing the processor to perform operations, comprising:
extracting a portion of text indicating a follow-up recommendation from the report;
extracting a name of the follow-up recommendation and determining a corresponding time interval from the portion of text;
extracting context information relating to the patient report; and
determining, based on the context information and the name of the follow-up recommendation, whether an appointment corresponding to the follow-up recommendation has been scheduled.
